(19) United States
(12) Patent Application Publication
(10) Pub. No.: US 2012/0245784 A1
(43) Pub. Date: Sep. 27, 2012

(54) METHOD FOR HANDLING DRIVE TORQUE AND/OR BREAKING TORQUE

(75) Inventors: Yvonne Wiegand, Kressbronn (DE); Markus Eisele, Friedrichshafen (DE)

(73) Assignee: ZF FRIEDRICHSHAFEN AG, Friedrichshafen (DE)

(21) Appl. No.: 13/513,868

(22) PCT Filed: Nov. 22, 2010
(86) PCT No.: PCT/EP2010/067886

§ 371 Date: Jun. 5, 2012

(30) Foreign Application Priority Data
Dec. 10, 2009 (DE) 10 2009 054 466.6

(51) Int. Cl. B60W 20/00; B60W 30/18; B60W 10/08; B60W 10/18; B60W 50/00; B60W 10/06

(52) U.S. Cl. 701/22

(57) ABSTRACT

A method for the control-side handling of drive torque and/or braking torque in a motor vehicle having as a drive assembly which comprises a hybrid drive with an internal combustion engine (1) and at least one electric machine (2). An engine control device (3) is assigned to the internal combustion engine and a hybrid control device (4) is assigned to the, or each, electric machine. The engine control device (1) and the hybrid control device (4) send and receive drive-torque-relevant and/or braking-torque-relevant data via a data bus (5), and further control devices (6, 7, 8) likewise send and receive drive-torque-relevant and/or braking-torque-relevant data via the data bus. The drive torque and/or braking torque is centrally managed by the hybrid control device (4).

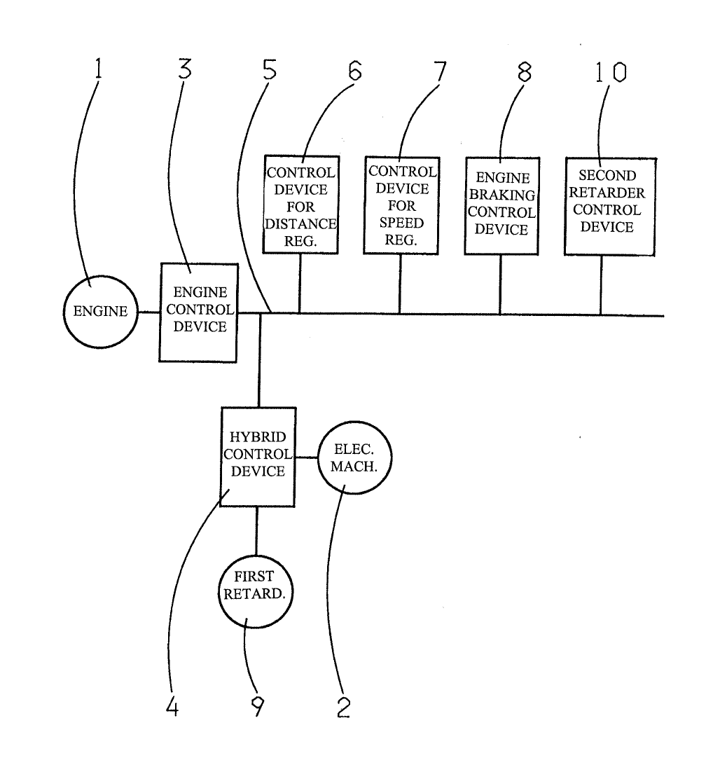

This application is a National Stage completion of PCT/EP2010/067886 filed Nov. 22, 2010, which claims priority from German patent application serial no. 10 2009 054 466.6 filed Dec. 10, 2009.

### FIELD OF THE INVENTION

The invention relates to method for the control-side handling of drive torque and/or braking torque in a motor vehicle having a hybrid drive.

### BACKGROUND OF THE INVENTION

A motor vehicle having a drive assembly designed as a hybrid drive has an internal combustion engine and at least one electric machine. The, or each, electric machine of the hybrid drive can be operated as a motor or as a generator, wherein in the case of motor operation of the respective electric machine of the hybrid drive, a drive torque is provided thereby, and the conversion of electric energy into mechanical energy discharges an electric energy store of the motor vehicle. In contrast, in the case of generator operation of the respective electric machine, the electric machine converts mechanical energy into electrical energy in order to charge the electric energy store of the motor vehicle. The, or each, electric machine of the hybrid drive can also provide a braking torque in generator mode.

An engine control device is assigned to the internal combustion engine, and a hybrid control device is assigned to the, or each, electric machine, wherein the operation of the internal combustion engine can be controlled or regulated using the engine control device and the operation of the, or each, electric machine can be controlled or regulated using the hybrid control device. The engine control device and the hybrid control device are connected to a data bus, wherein the engine control device and the hybrid control device send and receive data via the data bus. In addition to the engine control device and the hybrid control device, further control devices that likewise send and receive data via the data bus are connected to the data bus.

The further control devices can be, for example, a control device for controlling distance, a control device for controlling speed, a control device for managing braking and a control device of a retarder. The retarder can also be controlled by the hybrid control device, because conventional control devices generally cannot communicate with more than one drive assembly or braking assembly, wherein in this case there is not a separate control device for the retarder. Until now, the control-side handling of drive torque and/or braking torque has presented difficulties in motor vehicles having a hybrid drive. Under certain circumstances unsafe operating states can result for the motor vehicle.

### SUMMARY OF THE INVENTION

Starting from this, the problem addressed by the present invention is to create a novel method for the control-side handling of drive torque and/or braking torque in a motor vehicle having a hybrid drive. This problem is solved by a method according to the invention with which drive torques and/or braking torques are centrally managed by the hybrid control device.

With the present invention, it is proposed for the first time that the hybrid control device, in the sense of a central manager, centrally manages drive torques and/or braking torques of the internal combustion engine and drive torques and/or braking torques of the, or each, electric machine, as well as possible braking torques of other braking systems, such as an engine brake and/or at least one retarder. As a result, in every operating mode it is possible to consider the respective drive torque and/or braking torque provided by the internal combustion engine as well as the respective drive torque and/or braking torque provided by the, or each, electric machine for the operation of the motor vehicle, particularly for the control thereof.

Unsafe operating states of the motor vehicle, which could result from the failure to take into account one of these torques, are therefore avoided.

### BRIEF DESCRIPTION OF THE DRAWINGS

Preferred further developments of the invention will become apparent from the description that follows. An embodiment of the invention is described in more detail, without being restricted thereto, based on the FIGURE. The sole FIGURE shows a block diagram for illustrating the method according to the invention.

### DETAILED DESCRIPTION OF THE PREFERRED EMBODIMENTS

The FIGURE shows a very schematic block diagram of a motor vehicle having a hybrid drive, wherein the hybrid drive comprises an internal combustion engine 1 and an electric machine 2. An engine control device 3 is assigned to the internal combustion engine 1 of the hybrid drive. A hybrid control device 4 is assigned to the electric machine 2 of the hybrid drive.

The engine control device 3 and the hybrid control device 4 are connected to a data bus 5, which is typically implemented as a CAN data bus, wherein the engine control device 3 and the hybrid control device 4 send and receive data, particularly control relevant data, via the data bus 5.

According to the FIGURE, further control devices 6, 7, and 8 are connected to the data bus 5, for example, namely a control device 6 for regulating distance, a control device 7 for regulating speed, and an engine braking control device 8. The control devices 6, 7, and 8 also send and receive data via the data bus 5.

A first retarder 9 is connected to the hybrid control device 4 just like the electric machine 2. A further control device 10 of a second retarder is connected to the data bus 5 and sends and receives data via the bus.

According to the present invention it is proposed that in tractive mode of the motor vehicle, the hybrid control device 4 centrally manages drive torques and/or that in coasting mode of the motor vehicle, the hybrid control device 4 centrally manages braking torques.

The hybrid control device 4 manages the drive torques and/or the braking torques centrally such that, on the one hand, the hybrid control device 4 exclusively receives and/or evaluates drive-torque-relevant and/or braking-torque-relevant data sent via the data bus 5 by the engine control device 3, as well as drive-torque-relevant and/or braking-torque-relevant data sent via the data bus by the further control devices 6, 7, 8, 10, and on the other hand, the engine control device 3 and the further control devices 6, 7, 8, 10 exclusively receive and/or evaluate drive-torque-relevant and/or braking-torque-relevant data sent by the hybrid control device 4 via the data bus 5.

The engine control device 3 sends drive-torque-relevant data via the data bus 5, wherein the drive-torque-relevant data sent by the engine control device 3 can be received and/or can be evaluated exclusively by the hybrid control device 4. The hybrid control device 4 combines the drive-torque-relevant data sent by the engine control device 3 with the drive-torque-relevant data of the electric machine 2 into a total drive torque of the hybrid drive that is provided and/or can be provided in the motor vehicle.

The hybrid control device 4 provides this total drive torque of the hybrid drive at the data bus 5 or sends the same via the data bus, such that the further control devices 6, 7, 8, and 10 can access the total drive torque of the hybrid drive.

For this purpose, the engine control device 3 sends the drive-torque-relevant data thereof with a proprietary identification via the data bus 5, wherein the proprietary identification of the drive-torque-relevant data of the engine control device 3 can be received and/or can be evaluated exclusively by the hybrid control device 4. The hybrid control device 4 sends via the data bus the total drive torque of the hybrid drive with an identification that can be received and/or evaluated by the further control devices 6, 7, 8, and 10.

The control devices 6, 7, 8, and 10, which, where necessary, request a drive torque from the hybrid drive or influence the drive torque to be provided by the hybrid drive, likewise send the drive-torque-relevant data thereof via the data bus 5, wherein the drive-torque-relevant data sent by the further control devices 6, 7, 8, and 10 can be received and/or evaluated exclusively by the hybrid control device 4. Accordingly, the hybrid control device 4 receives the drive torques requested by the further control devices 6, 7, 8, and 10 or drive torque requests, and divides the drive torque request for the hybrid drive between the internal combustion engine 1 and the, or each, electric machine 2.

The hybrid control device 4 then sends corresponding partial drive torque requests, namely a partial drive torque request for the internal combustion engine 1 and a partial drive torque request for the electric machine 2.

The partial drive torque request sent by the hybrid control device 4 via the data bus 5 for the internal combustion engine 1 is sent by the hybrid control device 4 via the data bus 5 with a proprietary identification that can be received and/or evaluated exclusively by the engine control device 3.

Therefore, according to the present invention, in tractive mode of the motor vehicle, the hybrid control device 4 centrally manages all drive torques of the motor vehicle. The engine control unit 3 of the internal combustion engine 1 sends all drive-torque-relevant data with a proprietary identification on the data bus 5, wherein the further control devices 6, 7, 8, and 10 do not evaluate this data.

Only the hybrid control device 4 reads this drive-torque-relevant data of the engine control device 3, and combines this data with corresponding drive-torque-relevant data of the electric machine 2. The hybrid control device 4 issues the total drive torque generated by this combination to the data bus 5, wherein the further control devices can receive and/or evaluate this total drive torque. Accordingly, the further control devices 6, 7, 8 and 10 receive drive-torque-relevant data exclusively from the hybrid control device 4 which manages the total drive torque of the hybrid drive.

Conversely, the further control devices 6, 7, 8 and 10 transmit the drive-torque-relevant data thereof, particularly rotational-speed-relevant and/or torque-relevant engagement data, via the data bus 5 to the hybrid control device 4, which in turn centrally manages the data, and divides the same into partial requests for the internal combustion engine 1 and the, or each, electric machine 2 of the hybrid drive.

Accordingly, the drive-torque-relevant data sent by the further control devices are not directly received and evaluated by the engine control device 3, but rather, exclusively by the hybrid control device 4, which generates therefrom the corresponding partial drive torque requests for the internal combustion engine 1 and the electric machine 2 of the hybrid drive. The hybrid control device 4 provides the partial drive torque request for the internal combustion engine 1 on the data bus 5 using a proprietary identification.

Braking-torque-relevant data are handled in an analogous manner. Thus, according to the present invention, an engine braking control device 8 and/or the control device 10 of the second retarder sends braking-torque-relevant data via the data bus 5, wherein the braking-torque-relevant data sent by the engine braking control device 8 and/or the control device 10 can be received and/or evaluated exclusively by the hybrid control device 4.

The hybrid control device 4 combines the braking-torque-relevant data sent by the engine braking control device 8 and/or control device 10 with corresponding braking-torque-relevant data of the, or each, electric machine 2, and with corresponding braking-torque-relevant data of the, or each, first retarder 9 that is installed in the motor vehicle. In this manner, a total braking torque of the hybrid drive that is provided and/or can be provided is generated, wherein the hybrid control device 4 sends this total braking torque of the hybrid drive via the data bus 5.

For this purpose, the engine braking control device 8 and/orthe control device 10 of the second retarder of the FIGURE, each send braking-torque-relevant data thereof with a proprietary identification via the data bus 5. This data can be received and/or evaluated exclusively by the hybrid control device 4.

Likewise, the first retarder 9 provides the braking-torque-relevant data thereof to the hybrid control device 4. The hybrid control device 4 generates the total braking torque of the hybrid drive, and sends the same via the data bus 5 with an identification that can be received and/or evaluated by the control devices 6, 7, 8 and 10.

Furthermore, the control devices 6, 7, 8 and 10 send the braking-torque-relevant data thereof via the data bus 5, wherein exclusively the hybrid control device 4 can receive and/or evaluate the data in order to determine a braking torque request of the hybrid drive.

The hybrid control device 4 divides the corresponding braking torque request between the engine brake, the, or each, electric machine 2, and the, or each, retarder 9 or 10, wherein the hybrid control device 4 sends a partial braking torque request for the engine braking with an identification that can be received and or evaluated exclusively by the engine braking control device 8. Furthermore, the hybrid control device 4 sends a partial braking torque request for the, or each, electric machine 2 thereto. Beyond this, the hybrid control device 4 sends a partial braking torque request for the first retarder 9 thereto, and for the second retarder, namely the control device 10 thereof, via the data bus 5.

With the method according to the invention for handling drive torques and/or braking torques in a motor vehicle having a hybrid drive, it is guaranteed both in tractive mode and in coasting mode of the motor vehicle, that a total torque or summed torque of the assemblies which can provide a drive torque and/or a braking torque at the drive of the motor vehicle is always available and is considered for the control.

As a result, unsafe operating modes of a motor vehicle , which could result from the failure to take into account one of these torques, are avoided.

Therefore, there is no danger, for example, when in tractive mode an anti-lock braking system wishes to reduce a drive torque in the drive train, that a drive torque provided by one, or each, of the electric machines of the hybrid drive is not considered. Further, there is no danger, for example, when in coasting mode a high braking torque is necessary but cannot be provided exclusively by using the engine braking, that braking torques that could be provided by retarders and by one, or each, of the electric machines are not considered.

The method according to the invention can be used while maintaining conventional control architecture in the motor vehicle. No hardware modifications are required. Solely the handling for sending and receiving the drive torque-side and/or braking torque-side data is modified.

With the present invention it is possible with little expenditure to guarantee safe and reliable handling of drive torques and/or braking torques in a motor vehicle having a hybrid drive.

### REFERENCE CHARACTERS

1 internal combustion engine

2 electric machine

3 engine control device

4 hybrid control device

5 data bus

6 control device for distance regulation

7 control device for speed regulation

8 engine braking control device

9 first retarder

10 second retarder control device

1-15. (canceled)

16. A method of control-side handling of at least one of drive torque and braking torque in a motor vehicle which has a hybrid drive, comprising an internal combustion engine and at least one electric machine, as a drive assembly, an engine control device being assigned to the internal combustion engine, and a hybrid control device being assigned to the at least one electric machine, the method comprising the steps of:
sending to and receiving from the engine control device at least one of drive-torque-relevant data and braking-torque-relevant data, via a data bus;
sending to and receiving from the hybrid control device at least one of the drive-torque-relevant data and the braking-torque-relevant data, via the data bus;
sending to and receiving from at further control devices at least one of the drive-torque-relevant data and the braking-torque-relevant data via the data bus; and
managing at least one of the drive torque and braking torque centrally with the hybrid control device.

17. The method according to claim 16, further comprising the steps of managing centrally, with the hybrid control device, at least one of the drive torque and the braking torque such that the hybrid control device exclusively at least one of receives and evaluates the at least one of the drive-torque-relevant data and the braking-torque-relevant data sent by the engine control device via the data bus, as well as the at least one of the drive-torque-relevant data and the braking-torque-relevant data sent via the data bus by the further control devices.

18. The method according to claim 16, further comprising the steps of managing centrally, with the hybrid control devices, the at least one of the drive torque and the braking torque such that the engine control device and the further control devices at least one of receive and evaluate exclusively the at least one of the drive-torque-relevant data and the braking-torque-relevant data sent by the hybrid control device via the data bus.

19. The method according to claim 16, further comprising the steps of sending the drive-torque-relevant data from the engine control device via the data bus, at least one of receiving and evaluating, exclusively by the hybrid control device, the drive-torque-relevant data sent by the engine control device,
combining, from the hybrid control device, the drive-torque-relevant data, sent by the engine control device, with drive-torque-relevant data of the at least one electric machine into a total drive torque of the hybrid drive, and
sending, from the hybrid control device, the total drive torque of the hybrid drive via the data bus.

20. The method according to claim 19, further comprising the steps of sending, from the engine control device, the drive-torque-relevant data thereof via the data bus with an identification that is at least one of received and evaluated exclusively by the hybrid control device, and
sending, from the hybrid control device, the total drive torque of the hybrid drive via the data bus with an identification that is at least one of received and evaluated by the further control devices.

21. The method according to claim 16, further comprising the steps of sending from the further control devices, via the data bus, the drive-torque-relevant data that is at least one of received and evaluated exclusively by the hybrid control device in order to determine a drive torque request, and
dividing, via the hybrid control device, the drive torque request between the internal combustion engine and the at least one electric machine.

22. The method according to claim 21, further comprising the step of sending, from the hybrid control device, a partial drive torque request for the internal combustion engine, via the data bus, with an identification that is at least one of received and evaluated exclusively by the engine control device.

23. The method according to claim 21, further comprising the step of sending, from the hybrid control device, a partial drive torque request for the at least one electric machine to the respective electric machine.

24. The method according to claim 16, further comprising the steps of sending, from the engine braking control device, the braking-torque-relevant data, via the data bus, at least one of receiving and evaluating the braking-torque-relevant data, sent by the engine braking control device, exclusively by the hybrid control device,
combining, via the hybrid control device, the braking-torque-relevant data sent by the engine braking control device with at least one of the braking-torque-relevant data of the at least one electric machine and braking-torque-relevant data of at least one retarder into a total braking torque of the hybrid drive, and
sending, from the hybrid control device, the total braking torque of the hybrid drive, via the data bus.

25. The method according to claim 16, further comprising the steps of sending, from a control device of a retarder connected to the data bus, braking-torque-relevant data via the data bus,
sending the braking-torque-relevant data by the control device of the retarder is at least one of received and evaluated exclusively by the hybrid control device,
combining, via the hybrid control device, the braking-torque-relevant data sent by the control device of this retarder with at least one of the braking-torque-relevant data of the at least one electric machine, braking-torque-relevant data of a retarder connected to the hybrid control device and braking-torque-relevant data of an engine braking control device, into a total braking torque of the hybrid drive, and
sending, from the hybrid control device, the total braking torque of the hybrid drive via the data bus.

26. The method according to claim 24, further comprising the steps of sending, from at least one of the engine braking control device and the control device of the retarder connected to the data bus, which is connected to the data bus, the respective braking-torque-relevant data thereof with an identification that is at least one of received and evaluated exclusively by the hybrid control device, and
sending, from the hybrid control device, the total braking torque of the hybrid drive via the data bus with an identification that is at least one of received and evaluated by further control devices.

27. The method according to claim 26, further comprising the steps of sending, from the further control devices, via the data bus the braking-torque-relevant data which is at least one of received and evaluated exclusively by the hybrid control device to determine a braking torque request, and
dividing, via the hybrid control device, the braking torque request between the internal combustion engine, the at least one electric machine, and the retarder.

28. The method according to claim 27, further comprising the step of sending, from the hybrid control device, a partial braking torque request for the engine braking, via the data bus, with an identification that is at least one of received and evaluated exclusively by the engine braking control device.

29. The method according to claim 27, further comprising the step of sending, from the hybrid control device, a partial braking torque request for the at least one electric machine to the respective electric machine.

30. The method according to claim 27, further comprising the step of sending, from the hybrid control device, a partial braking torque request for the at least one retarder to the respective retarder.
